(19) United States
(12) Patent Application Publication
(10) Pub. No.: US 2005/0288981 A1
(43) Pub. Date: Dec. 29, 2005

(54) Method and apparatus of customer support through the use of automated assistance technology, live customer support, and predictive account maintenance and management for industries where there are services which relate to a customer account(s).

(75) Inventors: Aurelio Elias, Hurst, TX (US); Marcus Evan Gobel, Las Vegas, NV (US)

Correspondence Address: AURELIO ELIAS, 845 WEST CHERYL AVENUE, HURST, TX, 76053, US

(73) Assignee: Aurelio Elias, Hurst, TX (US)

(21) Appl. No.: 11/160,555

(22) Filed: Jun. 28, 2005

Related U.S. Application Data
(60) Provisional application No. 60/583,917, filed on Jun. 29, 2004.

(51) Int. Cl. G06F 17/00

(52) U.S. Cl. 705/7

(57) ABSTRACT

The present invention generally relates to a customer support methodology which can be enacted with a combination of automated support solutions and support technicians for industries where there are services which relate to a customer account(s). Its main purpose is the effective use and acquisition of data to better understand the customer, the product/service, and the support system in order to better handle support issues that have and could possibly happen. The innovation in customer support methodologies are established in key general areas: profiling, support session routing, authorization, verification, data convergence, data protection, communication, predictive analysis, government compliance, customer satisfaction, and preemptive actions.

This application claims the benefit under Title 35, United States Code, Sections 111(b) and 119(e), relating to Provisional Patent Applications, of the filing date of U.S. Provisional Patent Application Ser. No. 60/583,917 filed Jun. 29, 2004 of Aurelio Elias and Marcus Gobel for (Title) Method and apparatus of customer support for a financial instrument program through the use of automated assistance technology and predictive account maintenance/management.

### BRIEF SUMMARY OF THE INVENTION

The present invention resides in the methodologies for Software and methodologies using artificial intelligence, automated processes, Human Interaction, proprietary methodologies, and data convergence with converged data (including past customer data) to prepare for the eventuality and examine anomalies (including suspicious activity) to achieve a greater than 95% confidence level (where a conclusion can be reached) using accepted and established statistical inference.

The present invention generally relates to a customer support methodology which can be enacted with a combination of automated support solutions and support technicians for industries where there are services which relate to a customer account(s). Its main purpose is the effective use and acquisition of data to better understand the customer, the product/service, and the support system in order to better handle support issues that have and could possibly happen. The innovation in customer support methodologies are established in key general areas: profiling, support session routing, authorization, verification, data convergence, data protection, communication, predictive analysis, government compliance, customer satisfaction, and preemptive actions.

The system utilizes a combination of communication methods to take a proactive approach to determining the vulnerability, security, compliance, effectiveness of usage, and overall customer satisfaction of a product/service with a minimal support staff. The system uses Predictive Account Maintenance and Adaptive Support Reasoning to provide a system for analyzing events and the customer to provide automated methodologies for clarifying and acting upon knowledge of the customer, product, and system. This methodology increases the productivity and effectiveness of support personnel through a process of analyzing events and user interactions (with the system) to supply behavioral information to the support staff. The support staff then has the ability to specify conditions in which the system must initiate communication to the user through automated telephony, email, or other communication methods and/or signal an analysis event within the system. The conditions can be generic, recognized patterns of activity, or a random sample of a specific set of accounts.

This invention provides a method which finds the best expert to answer a consumer's question and take an appropriate action to resolve consumer issue. In another embodiment, this invention provides for a system for and method of protecting the privacy and identity of the consumer. The system can determine the appropriate action to evaluate and mitigate risk involved in suspicious activity and implement it without waiting for the customer to contact the support. Such ability is based on predictive account maintenance, adaptive support reasoning, dynamic knowledgebase, and rules based analysis. Using automated assistance, the consumer can perform many activities that previously can be done only with direct interaction with live customer support personnel.

The system has knowledge of relevant customer activity and uses this in the analysis by the system and by support personnel. The system enhances this data to make rational decisions by contacting the customer or merchant to: verify information, learn from the customer by their reactions, or to simply alert the customer to recent activity relevant to their account.

### BACKGROUND OF THE INVENTION

Predictive maintenance was first utilized to a great extent in financial service related industries where hardware failures could be detrimental. Hardware and hardware maintenance was expensive since computers were very large and required a great deal of onsite service. Hardware was also not mass produced as it is today which made components more expensive and in less supply.

A system was put in place to predict hardware failures and plan service and replacement of system components. This took into consideration the real-world use of the components. This ranged from the low level hardware specification to how the system used the components. Many factors were considered into this methodology for overcoming vulnerabilities, maximizing uptime, and optimizing performance.

The knowledge gained was used to take preemptive actions. These actions balanced cost and service level by adjusting the service schedules for each component and/or system. A simple example would be to know that a certain hard drive was receiving a high volume requests for an extending period of time without rest. That particular hard drive has issues under consistent stress. The methodology would continue to alert risk of failure of that unit and specify that a replacement unit be sent. It would then be scheduled for installation on the next routine service call or a new service call would be scheduled if the risk of failure was too great. This methodology automated the computer service industry for mission critical systems.

Hardware cost is much lower today and performance is much greater than before. The greatest resource and cost of a system is software and software development. Functionality is now a function of the capabilities of the software that runs the platform, this has led to more complexity in the services offered to account based customers. The paradigm has now been shifted to hardware support being the main focus for support of the service program.

The traditional solution for customer support is a live operator call center. Live operator call centers are both expensive and pose security risks. Web based support is available for customer support but some customers prefer phone based support or do not have internet access. A significant number of customers are not satisfied with Interactive Voice Response (IVR) systems as they are today. A significant number of customers are not satisfied with the knowledge and service level of live call center operators. This is partially due to the implementation of call center systems based upon a knowledgebase rather than having first-hand knowledge of the account activity or the customer. The support operators simply lookup problems in a database called a knowledgebase. The operator's job is to assess the customer's problem and communicate the information from the knowledgebase to the customer. This may require the customer to answer redundant questions and thus may become frustrated with the process. Customers often expect an immediate resolution of the problem even if it is not possible because a secondary investigation is needed. Problems can be magnified when they are related to financial instruments because these products deal directly with an individual's money.

A system is needed that can focus an individual support staff member's efforts and knowledge for handling similar problems across an account base and allow the system to communicate back the solution. This system also must be able to collect information directly and indirectly from the customer in order to help isolate possible issues across the account base. This information will also give the support staff a better understanding of the user and the world around the financial instrument. The support staff will also be able to better understand the effects of the user experience that the customer support system has on their behavior. This method is called predictive account maintenance.

### BRIEF DESCRIPTION OF THE DRAWINGS

Various elements of the invention are illustrated in the FIGURES appended hereto:

FIG. 1 diagrams the process of identifying and evaluating the System Event.

FIG. 2 illustrates the rules process once the System Event has been evaluated.

FIG. 3 illustrates the process used when the System Event is identified as a request for information.

FIG. 4 illustrates the automated process of contacting the customer via the automated process (i.e. web or phone) once the SE is established as an Interactive Support Session Event.

FIG. 5 is a diagram that illustrates communication methodology example 2: transaction processing.

Definition List 1

| Term | Definition |
|---|---|
| Predictive Account | A usage of predictive maintenance that |
| Maintenance (PAM) | provides for a method of applying |
| | predictive maintenance algorithms and |
| | methodologies to a general support |
| | context. |
| Adaptive Support | A methodology for applying |
| Reasoning (ASR) | characteristics of events to an account or |
| | multiple accounts or overall system for |
| | analysis and basis for logical |
| | assumptions. |
| Adaptive Support | This methodology pertains to the use of |
| Presentment (ASP) | including voice inflexion & graphic voice |
| | pattern analysis, phrasing, and/or order |
| | of questions and statements to the level |
| | of the individual to increase the comfort |
| | level and effectiveness of communication |
| | with the customer utilizing ASR. |
| Business Rule (BR) | A rule is a structure inside the system |
| | consisting of two parts: circumstances |
| | which this structure applies to, and what |
| | to do if the circumstances set for the |
| | rule apply. |
| Default Rule (DR) | All circumstances are not known initially. |
| | New combinations of circumstances are |
| | found as the system runs. When a new |
| | circumstance is discovered, a rule must |
| | be applied. This rule must apply to that |
| | circumstance till the circumstance can be |
| | evaluated properly by the system or an |
| | individual. The DR is that rule. |
| Human Interaction | This includes anytime an individual |
| (HI) | interacts with the product directly or |
| | indirectly. This can be the customer |
| | support agent talking to the device or |
| | service customer about the product or |
| | services. |
| Interactive Support | This involves a session of |
| Session (ISS) | communication between a customer and |
| | a support system (automated or HI) |
| System Event (SE) | This includes all events and interactions |
| | with the system or product/service |
| | directly or indirectly that the system |
| | becomes aware of directly or indirectly. |
| | This can include contacting support. This |
| | can be calling sales about product add- |
| | ons. This can also include use of the |
| | product/service. At the same time, this |
| | can include non-use of the product for a |
| | specified time since another event. This |
| | can be that a product use or service |
| | follows a specified pattern. That type of |
| | an event refers to a result of the systems |
| | analysis of an event or an account which |
| | the match or non-match is an event in |
| | itself. |
| Authorization Event | Important to customer support is fraud |
| (AE) | and privacy protection since support |
| | requires information to be disclosed in |
| | some way to an individual or external |
| | entity. This requires authorization on all |
| | SE's involving this kind of information |
| | disclosure. |
| System Process (SP) | The system has coordinated sets of |
| | actions which are controlled and enacted |
| | by the system. These actions might |
| | happen immediately or over an |
| | undetermined amount time. |
| Automated | The system communicates with an |
| Communication | outside entity directly or indirectly. This |
| Process (ACP) | can include calling an individual using a |
| | phone number. This can include other |
| | methods such SMS. This can also include |
| | leaving a voicemail message. This can |
| | also include the communication when a |
| | user calls into an IVR system. This can |
| | also include the system responding with |
| | a prepared message or set of messages |
| | not directly to a direct request from the |
| | user. |
| Learning Process | Ability to add new BR, or set of BR, based |
| (LP) | on evaluation of the SE. New BR can be |
| | added during Human Interaction (HI), or |
| | System Process (SP). |
| Predetermined | This is an automated support |
| Branching | methodology which has a fixed set of |
| Path (PBP) | actions/responses particular to each |
| | event. All stages are planned in advance |
| | to follow predetermined paths. |
| Event Driven | A break in the normal support path |
| Dynamic Support | which is based upon SE's. A normal path |
| Path (EDDSP) | is a set path based upon a branching |
| | script. A normal path can have look-up |
| | actions but their resulting actions are |
| | selected from a predetermined set. An |
| | EDDSP is based upon evaluations of SE's. |
| Support Session | A customer support session has its own |
| Profile (SSP) | characteristics. These characteristics |
| | include pertinent information such as |
| | length of session, how initiated, |
| | customer endpoint, customer |
| | satisfaction, and all options selected. |
| Converged Data | Data is acquired from traditional and |
| (CD) | internal resources including but not |
| | limited to support sessions, customer |
| | personal information, and |
| | product/service usage. This data is |
| | analyzed for known and unknown |
| | characteristics by system processes |
| | and/or human interaction. The resulting |
| | data including known and new |
| | characteristics is the converged data. |

### DETAIL DESCRIPTION OF THE INVENTION

The automated system includes the following aggregates:
(1) IVR Telephony system
(2) Web base communication system
(3) Data base system
(4) SMS communication system
(5) E-mail system
(6) Software Engine that is capable of analyzing account activity and applying the rules
(7)

The innovation in customer support methodologies are established in key general areas: profiling, support session routing, authorization, verification, data convergence, data protection, communication, fraud detection/prevention, government compliance, and customer satisfaction. The invention is described as a series of components as many actions happen simultaneously. The components are listed first then the implementation areas.

The PAM implementation involves:
(1) Collecting information relevant to usage or support of a product or service which is generated by the normal operation of the business.
(2) Evaluating the characteristics of events running through an automated system. (ASR).
(3) Adjusting the characteristics of the relevant accounts and other relevant objects based upon the characteristics of the event (ASR).
(4) Forming new classifications for characteristics based upon combinations or patterns of other characteristics (ASR).
(5) Recognize patterns of characteristics through analysis and set BR's (ASR).
(6) Apply actions to BR's.
(7) Apply automated and traditional information gathering techniques to augment current information or to validate an assumption in order to: gain the participation of the consumer or merchant in the security of the system, verify information, learn from the customer by their reactions, or to simply alert the customer to recent activity relevant to their account (ASR).
(8) This includes adjusting the way communication is handled with the customer such as including voice inflexion & graphic voice pattern analysis, phrasing, and/or order of questions and statements to the level of the individual (ASP).
(9) Apply the BR's to have the appropriate personnel or systems communicate with the consumer to either acquire information and/or rectify their issue.

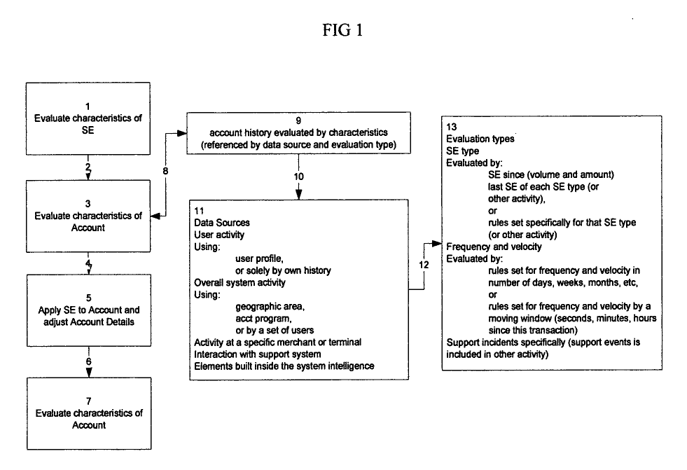

The automated process starts with the SE. A SE is evaluated in a number of different ways. To begin, there is an initial analysis process. This process evaluates the characteristics of the event itself. The current status of the account is evaluated before the SE is applied. The SE is then applied to the account. The account is then evaluated again for certain characteristics after the SE was applied to the account. This process can be quite involved depending on the number of known characteristics and the discovery process for new characteristics. These characteristics can be simple, full profiles, or even algorithms. FIG. 1 illustrates the process of evaluating the SE.

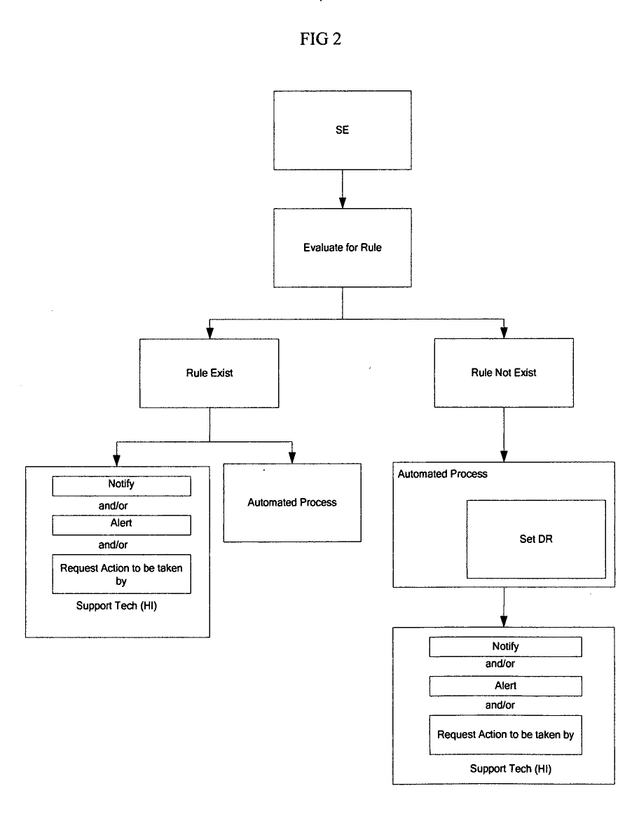

Rules are set which look for certain characteristics. These rules can contain: value ranges, specific value, algorithm, bitmap, or other data structures which contain specific values or algorithms for comparisons including bitwise. A rule can also be a set of rules with an action set. In this case, which of the contained rules evaluate true determines the action(s). An action is taken when a rule comparison evaluates to true. The type of action that is taken can be influenced by the origin of the analysis. This is the case because different SE's hold different purposes. Some SE's are for immediate responses to a human. These SE's have a critical time issue and involve communication systems. Some SE's require establishing communication to an individual and immediate action to the account such as disabling the account because of fraud or changing the PIN (Personal Identification Number). Some events are part of an analysis SE to better understand the card holder or other accounts. Each type has its own issues and types of actions. FIG. 2 refers to Rules process.

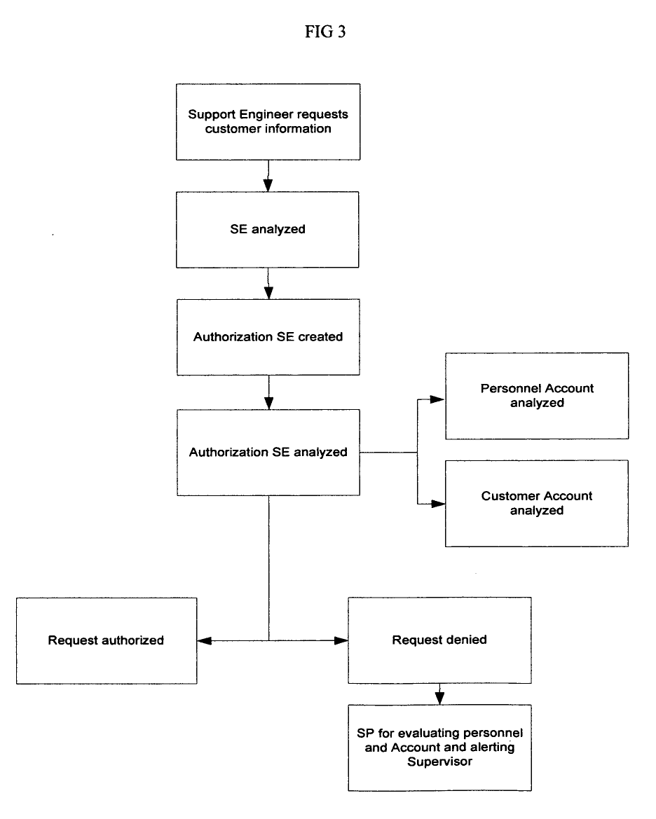

Another type of SE is a request for information. This type of SE necessitates an AR. Important to customer support is fraud and privacy protection. This requires authorization on all SE involving disclosure of sensitive information. FIG. 3 illustrates the information SE.

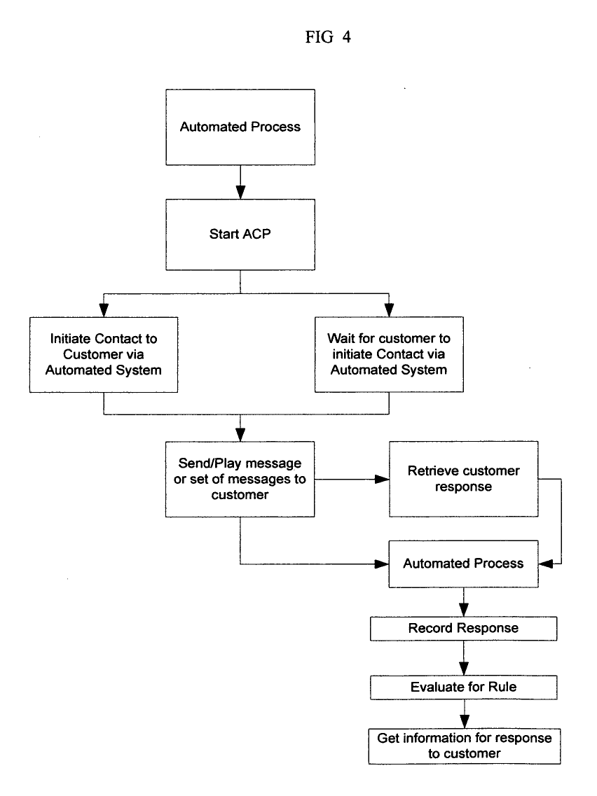

Another type of SE is an ISS. During ISS, the system must decide how to respond to the individual upon each request and after the conclusion of each message. This involves either a PBP or an EDDSP. The EDDSP can have been initiated by a BR before the session begins. An EDDSP can also have been triggered directed by a Support Technician or a SP. FIG. 4 refers to AP.

Pre-Session triggered EDDSP's involve launching a SP. This SP either starts a series of actions which establish communication with the customer or other relevant parties (including the support technician and even a merchant) or sets a wait event to be launched for a specific event. The wait event could be as simple as waiting for a user to contact an automated support system or might be as specific as waiting for the user to perform a specific action when certain BR's apply. This second type of EDDSP can also be triggered during a session by the matching of one or more BR's. In-Session EDDSP's start immediately and take over the support session. To allow new SEs to be classified in a SP, there are DRs. When a new SE is discovered by analysis, the system must know how to handle this SE. This is also used for an individual to classify and assign rules to SEs that the support technician does not know how to handle. A DR can be used to simply instruct the system to log the SE to use for further analysis. DRs also have a special role for existing SEs. When no other rules evaluate to true for a SE, the DR is applied. This also allows a rule to simply have a DR. The DR in this case just provides the action to be applied (no comparison component).

These methods are used for a number of purposes. The method with which data is collected and applied is known as data convergence. This in itself is an innovation of the invention. Information can be gathered in traditional methods: direct question and answer, form (paper or online), volunteered by the customer, and gathered through third party sources. This information is used in combination with information collected from SE's (which includes events from support and usage of the product/service). This includes but not limited to information gathered from: PBP, EDDSP, ACP, and general ISS. Information can also be derived from SP including results of analysis. Information being added involves a SE. This SE is evaluated by a SP. This creates a method of assimilating the information into the account and the system otherwise known as ASR. The resulting data is known as CD.

Customer profiling is key to knowing the customer. This involves grouping the customers into known behavioral profiles by information gathered about them (credit checks, enrollment questions, or other personal information) and understanding their behavior. This provides an insight into the customers behavior and knowledge level in order to effectively handle the customer by knowing why a customer does things and how to effectively communicate with the individual. This is also used in finding possible fraud and suspicious activity. In a generic possible fraud scenario, actions are performed that do not seem to match the customer's usually behavior and/or fall outside the profile category. An example behavioral profile would be a customer who only uses their debit card for gas. Another would be a customer that does not know the rules of the service program and calls customer support each time they misuse the service. The innovation (within the invention) in customer profiling is both in the way information is collected and how it is applied to the account. Inside each account is an active profile of the customer. This has two main components: the similar system profile (known behavioral profile) and the information (real and aggregate) about the actual activity. The known behavioral profile can change on an account when evaluating each SE.

BR's are also assigned directly to known behavioral profiles. This means that when BR's are changed on a known behavioral profile the changes are propagated to each account where the profile matches.

Customer contact is also initiated when the information is unclear to properly profile the customer. This is common when the system is trying to figure whether an action is suspicious or the system needs to change the customer profile. This contact can also be a random sample of a given known behavioral profile.

Key to any program's success is customer satisfaction. There are many factors which affect a customer's satisfaction level beyond the merit of the product/service itself. The main factors are based upon the customer's perception of the service including: protection of the customer from fraud or other unwanted situations involving the product account, responsiveness to anomalies and the customer's concerns, ease of use, and understanding of what the customer is experiencing and feeling.

Addressing these concerns is part of the overall methodology. Specific to customer satisfaction is the method of employment by the invention to personalize the communication to the individual. The invention contains the ability to adapt the voice inflexion & graphic voice pattern analysis, phrasing, and/or order of questions and statements to the level of the individual. This communication methodology done utilizing the data existing in the customer account, the relevant known behavior profile, and the system on-the-fly using ASR.

Government compliance has become much more involved since the events that led to the Patriot Act. Services involved with transferable goods have to recognize and report suspicious activity. This can range from events involved in money laundering to events involved in carrying out terrorist activities. This requires knowledge of the customer and each event. This also requires analysis based upon the system as a whole and relationships between accounts. Suspicious activity can involve multiple accounts especially in services involving money transfer.

The methodology analyzes system data and performs analyses across multiple accounts. This is accomplished through either SP directly or a series of SE which are handled by SP. Customer and merchant contact is also initiated when the information is unclear to identify the situation as suspicious activity. ASP, ASR, and EDDSP become highly important during this type of ISS.

### EXAMPLE 1

The consumer has a total of $51 on their debit card account. The consumer uses their debit card at a gas pump to pay for gas. The POS device reserves $50 on the consumer's account for a period of one hour. The available balance on that account is now $1.50. The consumer decides not to get gas. The consumer then walks into to a convenience store to get a coffee for $1.50. The transaction is rejected for insufficient funds. The system recognizes this SE and prepares for the consumer. First, the system must evaluate why the customer would not use the product properly. This could be a result of a stolen card (or other fraud), inexperience with the system, or lapse of judgment. In the case of possible fraud, the card is suspended or activity is limited. The EDDSP is formed to confirm or deny possible fraud and to help the consumer. In the case of inexperience with the system, the customer needs to be educated. The EDDSP is formed to educate the customer and try to make them comfortable with the way the system works. In the case of lapse of judgment, the EDDSP is formed more particularly to the user. Then the customer is contacted if possible and practical. The system is also prepared for the customer to initiate contact. When contact is made and verified, the EDDSP is started.

### EXAMPLE 2

### Transaction Processing

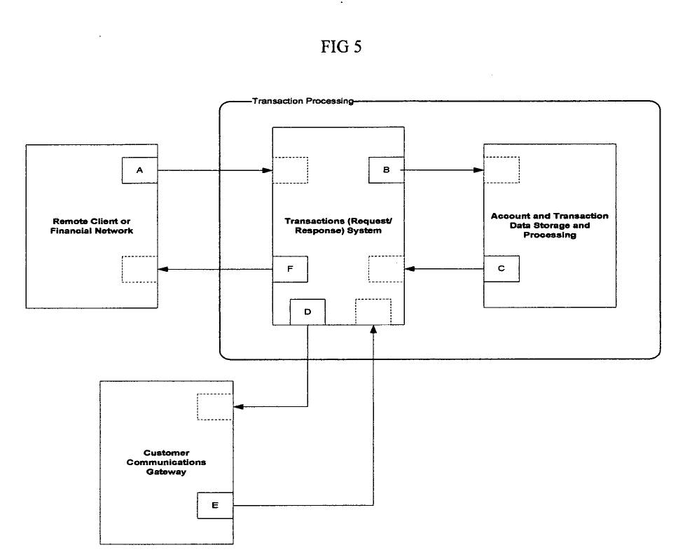

(1) The transaction is sent by the RC or FN. The message is received by the TRRS.
(2) The Transaction System validates/parses/pre-processes the message. The data is prepped and sent to the ATDSP.
(3) The transaction is stored inside the database along with transaction fee. The transaction history is evaluated.
(4) The result is sent to the TRRS. If a communication needs to be established with the customer:
(5) A message detailing the communication is sent to the CCG.
(6) A message is sent to the TRRS with instructions on how to finish the transaction.
(7) The TRRS sends a transaction complete message to the RC.
   Error! Reference source not found. refers to example of Transaction Processing FIG. 5

1. Software and methodologies using artificial intelligence, rules-based methodology, automated processes (including SP), Hl, enhanced industry specific methodologies (where applicable), and data convergence with CD (including past customer data) to prepare for the eventuality and examine anomalies (including suspicious activity) to achieve a greater than 95% confidence level (where a conclusion can be reached) in achieving virtually infallible results using accepted and established statistical inference.

2. The method of claim 1 wherein a AP is used for data convergence (resulting in CD) to assimilate data by evaluating SE's (and the relevant account) in a structured process comprising the steps of:.

3. a) evaluating the characteristics of the SE itself
b) evaluating current status of the relevant account before the SE is applied
c) applying SE to the relevant account and adjusting the relevant account details
d) evaluating account again for certain characteristics after the SE was applied to the account.

4. The method of claim 2 wherein the evaluation of the characteristics of the relevant account include the “account history evaluated by characteristics” referenced of FIG. 1.

5. The method of claim 1 wherein the PAM algorithm has the capability to invoke the SE and add new BR to the system.

6. The method of claim 1 wherein the system and methodologies protect against privacy intrusions using AE.

7. The method of claim 1 wherein a method is used to determine and invoke ACP, based upon SP or BR that was applied to the relevant SE as part of analysis or preparation for analysis.

8. The method of claim 6 wherein the system uses ACP to obtain first hand knowledge about the account holder's behavior when dealing with the product or service and that information is then used by the system in determining the methods of supporting the customer, recognizing changes of behavior, and identifying suspicious behavior.

9. The method of claim 2 wherein, based on evaluation of the SE (LP), a new BR or set of BR's is added to the system.

10. The method of claim 1 wherein a method is used of adapting the presentment of information involved in the system including voice inflexion & graphic voice pattern analysis, phrasing, and/or order of questions and statements to the level of the individual by utilizing CD (including account and system data), and the relevant known behavior profile in real-time using ASR.

11. Software and methodologies utilizing artificial intelligence, rules-based methodology, automated processes (including SP), Hl, enhanced industry specific methodologies (where applicable), and data convergence with CD (including past customer data) to prepare for the eventuality and authorization of transactions to achieve a greater than 95% confidence level (where a conclusion can be reached) in achieving virtually infallible results using accepted and established means of statistical inference.

12. The method of claim 10 wherein a AP is used for data convergence (resulting in CD) to assimilate data by evaluating SE's (and the relevant account) in a structured process comprising the steps of:.

13. a) evaluating the characteristics of the SE itself
b) evaluating current status of the relevant account before the SE is applied
c) applying SE to the relevant account and adjusting the relevant account details
d) evaluating account again for certain characteristics after the SE was applied to the account.

14. The method of claim 11 wherein the evaluation of the characteristics of the relevant account include the “account history evaluated by characteristics” referenced of FIG. 1.

15. The method of claim 10 wherein the PAM algorithm has the capability to invoke the SE and add new BR to the system.

16. The method of claim 10 wherein a method is used to determine and invoke ACP, based upon SP or BR that was applied to the relevant SE as part of analysis or preparation for analysis.

17. The method of claim 14 wherein the system uses ACP to obtain first hand knowledge about the account holder's behavior when dealing with the product or service and that information is then used by the system in determining the methods of supporting the customer, recognizing changes of behavior, and identifying suspicious behavior.

18. The method of claim 11 wherein, based on evaluation of the SE (LP), a new BR or set of BR's is added to the system.

19. The method of claim 10 wherein a method is used of adapting the presentment of information involved in the system including voice inflexion & graphic voice pattern analysis, phrasing, and/or order of questions and statements to the level of the individual by utilizing CD (including account and system data), and the relevant known behavior profile in real-time using ASR.

20. Software and methodologies utilizing artificial intelligence, rules-based methodology, automated processes (including SP), Hl, enhanced industry specific methodologies (where applicable), and data convergence with CD (including past customer data) for control and prioritization of access to system functions and “unlocking” of sensitive information to achieve a greater than 95% confidence level (where a conclusion can be reached) in achieving virtually infallible results using accepted and established means of statistical inference.

21. The method of claim 1 wherein a AP is used for data convergence (resulting in CD) to assimilate data by evaluating SE's (and the relevant account) in a structured process comprising the steps of:.

22. a) evaluating the characteristics of the SE itself
b) evaluating current status of the relevant account before the SE is applied
c) applying SE to the relevant account and adjusting the relevant account details
d) evaluating account again for certain characteristics after the SE was applied to the account.

23. The method of claim 19 wherein the PAM algorithm has the capability to invoke the SE and add new BR to the system.
